(19) United States
(12) Patent Application Publication
(10) Pub. No.: US 2007/0038634 A1
(43) Pub. Date: Feb. 15, 2007

(54) Method for targeting World Wide Web content and advertising to a user

(76) Inventors: Eric J. Glover, North Brunswick, NJ (US); Tomasz Imielinski, Princeton, NJ (US); Apostolos Gerasoulis, Edison, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/200,779

(22) Filed: Aug. 9, 2005

(51) Int. Cl. G06F 17/30

(52) U.S. Cl. 707/10

(57) ABSTRACT

According to one aspect of the invention, a method for managing the navigation of a visitor to the World Wide Web is provided. A target profile is determined based on a combination of at least two known properties and a navigation path is associated with the target profile. The at least two known properties are related to the at least one of a query, world knowledge, and information about a visitor to the World Wide Web. The visitor may be automatically directed along the navigation path.

### BACKGROUND OF THE INVENTION

1). Field of the Invention

This invention relates to a method and a system for managing the navigation of a visitor to the World Wide Web, and in particular, directing the visitor to particular navigation paths on the World Wide Web.

2). Discussion of Related Art

Literally millions of people in the United States alone search, or “surf,” the World Wide Web (WWW), or the “internet,” every day. The WWW has become an indispensable source of information for many different purposes. Visitors, or users, can search for information about particular subjects, buy various consumer goods, and make reservations for various events, such as at hotels and airline flights.

One of the major sources of revenue on the WWW is targeted advertising in which a user is directed to a particular advertisement based on a query entered by the user into what is commonly known as a “search engine.” Such targeted advertising is sometimes performed by a business purchasing lists of particular keywords, or categories of keywords, and when the keywords appear in a query, an advertisement for the company is automatically displayed on the user's computer.

Such advertising is often not sent to users actually interested in the advertised business because the determination whether or not to show a particular advertisement is based solely on whether or not particular keywords are in the current query. Other factors, such as combinations of words in the query and information about the user, are not taken into account.

For example, if a user searches for “parking tickets,” he or she will most likely be shown an advertisement for a business through which airline tickets may be purchased. This is because the keyword “tickets” was in the query. Therefore, the advertisement for the airline tickets was essentially wasted because the user was not interested in airline travel. Rather, he or she was more likely looking for information such as how to contest parking tickets.

### SUMMARY OF THE INVENTION

The invention provides a machine-implemented method for managing navigation across the World Wide Web including determining a target profile based on a combination of at least two known properties and associating a navigation path with the target profile. The at least two known properties may each be related to at least one of a query, world knowledge, and information about a visitor to the World Wide Web.

The method may further include receiving the at least one of a query, information about a visitor to the World Wide Web, and world knowledge; and associating each known property with the at least one of the query and the information about the visitor.

The visitor may be automatically directed to the navigation path associated with the target profile.

The properties may include categorizations of the at least one of a query, information about a visitor to the World Wide Web, and world knowledge.

The method may further include generating the properties using at least one of keyword matching, classification, advanced natural language processing, list matching, and ambiguity resolution. The list matching may include at least one of static and dynamic lists.

The information about the visitor may include at least one of the visitor's location, IP address, previous queries, demographic data, and previous navigation paths.

The properties may not include the query, and the navigation path to which the visitor is automatically directed may include dynamic text which includes the query.

The method may further include displaying information specific to at least one of the properties within the selected navigation path.

The properties may include categorizations that do not include the at least one of a query, information about a visitor to the World Wide Web, and world knowledge.

The selected navigation path may include an advertisement. The properties may be sent to a target company when the user selects the advertisement.

The generation of the properties may include at least one of correcting spelling of a term in the query, replacing an abbreviation in the query, and replacing alternative form in the query.

### BRIEF DESCRIPTION OF THE DRAWINGS

The invention is described by way of examples with reference to the accompanying drawings, wherein:

FIG. 1 is a flow chart illustrated a method for managing the navigation of a visitor to the World Wide Web;

FIG. 2 is a block diagram illustrating the method of FIG. 1 in greater detail and a system for implementing the method of FIG. 1;

FIGS. 3-6 are block diagrams illustrating specific examples of the method and system of FIG. 2;

FIG. 7 is a block diagram of a computing system; and

FIG. 8 is a block diagram of a computer networking system.

### DETAILED DESCRIPTION OF THE INVENTION

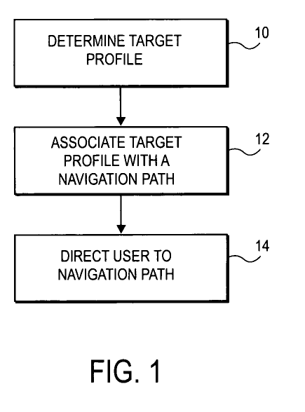

FIG. 1 illustrates a method for managing the navigation of a visitor, or user, to the World Wide Web (WWW), or the internet. At step 10, a target profile is determined. The target profile is determined by, or consist of, multiple “properties” or “characteristics” that relate to a query entered by the user, information about the user, and/or “real world” knowledge. At step 12, the target profile is associated with a particular navigation path on the WWW. The navigation path is, for example, a particular website, or webpage, or a particular advertisement advertising the goods or services of a particular vendor. Then, at step 14, the visitor is automatically directed to, or along, the particular navigation path to view the particular website.

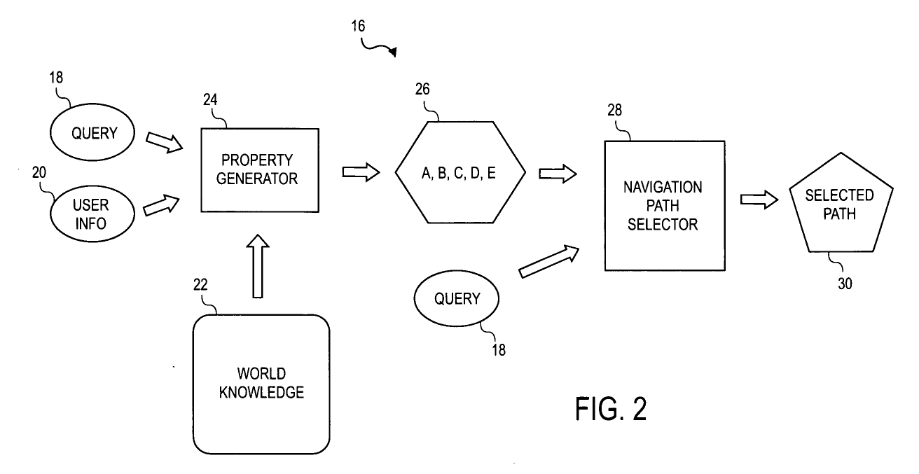

FIG. 2 illustrates the method of FIG. 1 in greater detail. First, a query 18 entered by the visitor into a search engine, information 20 about the visitor, or user, and real-world knowledge 22 are received as input into a property generator 24. The information 20 about the visitor includes, for example, the visitor location, IP address, past queries, demographic data, previous actions on the WWW, and other knowledge about the visitor or the intentions of the visitor.

The property generator 24 creates multiple properties 26, or characteristics, about the query 18, the information 20 about the visitor, and/or real-world knowledge 22, or any combination thereof. The properties 26 include, for example, categories into which the query 18 and the visitor may be included based on the information 20 about the visitor and real-world knowledge 22. The properties are created through various methods and sources, such as keyword matching, classification, natural language processing (NLP), list matching, advanced functions such as spell correction, ambiguity resolution, resolving a reference, and question answering technology. The properties can be based on static lists, dynamic lists, mathematical functions, or other functions. The property generator 24 can call on the real-world knowledge, including current events, to determine the static and dynamic lists on which the properties are based.

One example of a property function is P=f(q,S,H,W), where q is the current query, S is the current user session, H is user saved data and history, and W is the “world state” including external knowledge, such as lists and current events.

The properties 26 are then received into a navigation path selector 28. Although not illustrated in detail, the navigation path selector 28 includes a database including various combinations of the properties 26, as well as navigation paths on the WWW associated with the combinations of the properties 26. The query 18 may also be received into the navigation path selector 28 and be combined with the properties to create additional combinations from the query 18 and the properties 26. The navigation path selector 28 then selects particular, or selected, navigation paths 30 to which the user is to be directed.

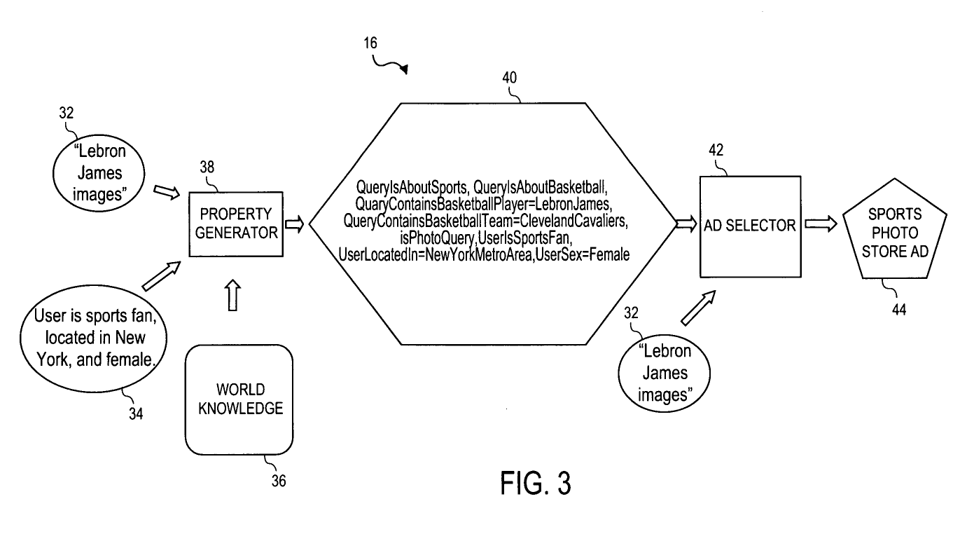

FIG. 3 illustrates a more specific example of the method and system 16 illustrated in FIG. 2. First, the query “Lebron James images” 32 is entered by the visitor, the information about the visitor “User is a sports fan, located in New York, and female” 34 is retrieved, and the real-world knowledge 36 is searched. The query 32, the information 34 about the user, and the real-world knowledge 36 are received by the property generator 38, which creates the properties 40. In the example illustrated, the properties 40 generated include “QueryIsAboutSports,” “QueryIsAboutBasketball,” “QueryContainsBasketballPlayer=LebronJames,” “QueryContainsBasketballTeam=ClevelandCavaliers,” “IsPhotoQuery,” “UserIsSportsFan,” “UserLocatedIn=NewYorkMetroArea,” and “UserSex=Female.”

The properties 40 generated by the property generator 38 include categories into which the query “Lebron James images” fits based on real-world knowledge 36. In the example illustrated, the real-world knowledge 36 contains further information about the National Basketball Association (NBA) player, Lebron James, who plays for the Cleveland Cavaliers. As is evident from the properties 40, the property generator 38 created the properties 40 by utilizing the real-world knowledge, including current news about sports. Thus, the property generator 40 determined that the query 32 is about sports and, in particular, a player for the Cleveland Cavaliers based on the fact that the name “Lebron James” was in the query.

It should thus be noted that the properties generated for particular queries may be dynamic. That is, due to changes in current events, different properties may be generated at different times for the same query. For instance, if Lebron James were to play for a different NBA team, such as the Phoenix Suns, the property regarding the Cleveland Cavaliers listed above would not be generated, but one including the Phoenix Suns would take its place.

Additionally, as is evident from the specific properties listed above, the property generator 40 utilizes the information 34 about the visitor to determine that the visitor is from New York, a sports fan, and female.

The properties 40 are then sent to the navigation path, or advertisement, selector 42. As previously discussed, the ad selector 42 includes various combinations of properties and navigation paths, such as advertisements, associated with the various combinations of properties. The associations between the properties, or combinations of properties, are predefined within the advertisement selector. Advertisers can purchase individual properties, or various combinations of properties, so that when the particular property or combination of properties is generated by the property generator, a selected advertisement is displayed to the user.

The advertisement selector 42 then selects a selected advertisement 44 based on the combinations of properties 40. In the example illustrated, the combination of the properties that the query is about basketball, the query contains a specific basketball player's name, and the query is a photograph query creates a very specific profile of the user and/or the user's query. Such a profile suggests that the user is looking to purchase, or at least view, photographs of Lebron James. Thus, the selected advertisement is for sports photograph store, where one may purchase photographs of professional athletes, such as Lebron James.

Although not illustrated in detail, the text of the advertisement may be dynamic to include text not specifically stated in the generated properties. For instance, in the example illustrated in FIG. 3, if the sports photograph store had not purchased the property specifically naming Lebron James, the ad selector may use the query, along with the other properties, to specifically show an advertisement for purchasing images of Lebron James despite the fact the advertiser did not purchase that specific property.

Additionally, a specific property, such as that the query is for the NBA player Lebron James, may be sent to specific site (i.e., of a target company) advertised so if the user chooses to open the advertised website, the website may provide additional, more specific, information about the user's query. For example, if the advertisement is for the sports photograph store mentioned above, if the user chooses to open the advertised website, he or she may be taken directly to a specific page on the advertised website where various photographs of Lebron James may be purchased, rather than taken to the homepage for the sports photograph store.

Referring again to FIG. 2, although not illustrated in detail, the negative of a property 26 may be used by the navigation path selector 28. A negative of a property is used when the query 18 or information 20 about the visitor does not fit into a category defined by a particular property, or simply the absence of a particular property. For example, if the query 18 is “Mark A. Kupanoff,” a name which does not appear in the current events, a property generated may include that the query is a person's name. The absence of a property that the person is a famous person may indicate that the person is not a famous person. The navigation path selector 28 may associate one or more properties and the absence of one or more properties with a navigation path 30 that would allow the visitor a means to find out contact information for the person in the query, such as an advertisement for an online phone number directory because it is likely that the user is searching for information is searching for contact information for that person.

Therefore, a company that specializes in directory listings may have its ads, or webpages, associated with properties which are triggered by queries that contain a person's name in the absence of a property indicating that the person is a famous person. As a further illustration, this particular company may include dynamic text in its advertisement such as “Click HERE for Directory Information about #PersonName,# where” #PersonName# indicates the name of the property (the person's name) that will be entered into the advertisement that is shown to the user.

However, if the query 18 is “George W. Bush,” a name that frequently appears in current events, because it is the name of the President of the United States, the properties may include that the query 18 is for a famous person. Therefore, the advertisement for the online phone number directory may not be associated with the combination of properties because it would seem unlikely that the visitor is actually attempting to contact such a famous person. Rather, the navigation path selector 28 may select a navigation path associated with the President of the United States.

The negative properties may be used to distinguish geographic regions. For example, an advertiser may wish to have an advertisement shown only if the user is not from a particular state, such as California. The properties generated by the property generator may include negative properties that describe locations where the user is not located. In this way, the advertiser who wishes to have the advertisement shown to users from all states except California simply needs to have the advertisement associated with one property, namely that the user is not from California, rather than have the advertisement associated with forty-nine properties, one for all of the other states in the United States.

As previously mentioned, the information about the visitor includes such items as the IP address of the visitor, previous queries by the visitor, and demographic data about the visitor. Such information is used to create more specific properties.

For example, if the query is “Giants,” the visitor could be looking for one of several different things, such as either the National Football League (NFL) team, the New York Giants, or the Major League Baseball (MLB) team, the San Francisco Giants. The property generator utilizes past queries by the visitor, current events, and information about the visitor to generate properties, which may differ at different times of the year. If the user has previously searched for various information about professional sports teams from the New York metropolitan area, such the New York Jets or the New York Knickerbockers, one of the properties generated may include that the visitor is a sport fan in the New York area. Thus, navigation path selected may be related to the New York Giants.

However, if the query takes place during the month of October, and the San Francisco Giants are playing in the World Series, one of the properties may include that the San Francisco Giants because of the World Series, and the navigation path selected may be related to the San Francisco Giants.

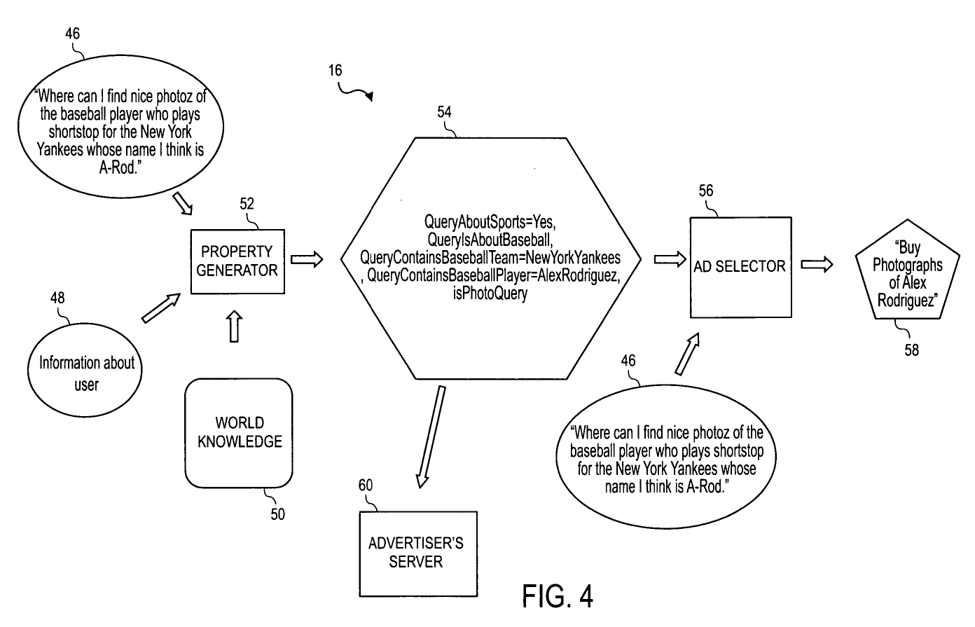

FIG. 4 illustrates another specific example of the method and system 16 illustrated in FIG. 2. The user enters the awkwardly phrased query 46 of “Where can I find nice photoz of the baseball player who plays shortstop for the New York Yankees whose name I think is A-Rod.”

It should be noted that the query 46 includes the misspelling of the abbreviation for “photographs” of “photoz” and the nickname for the baseball player Alex Rodriguez of “A-Rod.”

The query 46, information 48 about the user, and the real-world knowledge 50 relevant to the query 32 are then received by the property generator 52. Although not illustrated in detail, it should be understood that the system 16 may also take advantage of subsystems such as spelling correctors (i.e., to correct the spelling of a term in the query), query correctors and functions (e.g., to replace abbreviations in the query) “nickname detectors” (i.e., to replace a term in the query with an alternate form) and other language detectors to “correct” the query 23 and/or generate appropriate properties 54 about the query 46.

In the example illustrated, the properties 54 include, amongst others, “QueryIsAboutSports=Yes,” “QueryIsAboutBaseball,” “QueryContainsBaseballTeam=NewYorkYankees,” “QueryContainsBaseballPlayer=AlexRodriguez,” and “isPhotoQuery.”

Of particular interest in the example shown in FIG. 4 is the fact that the properties 54 include that the query concerns the MLB player Alex Rodriguez and identifies the query as a photo query despite the fact that neither Alex Rodriguez nor photographs were specifically named in the query 46. One possible way to generate such properties could be that the system 16 utilizes spelling correctors to correct “photoz” to “photos” and world knowledge and advanced algorithm to conclude that “A-Rod” refers to Alex Rodriguez of the New York Yankees.

Still referring to FIG. 4, the properties 54 are then sent to the ad selector 56 which, similarly as described above, selects an appropriate advertisement 58, or webpage, to show the user. As shown, the selected advertisement 58 is for a webpage/business to “Buy Photographs of Alex Rodriguez.”

It should also be noted that in the example illustrated in FIG. 4, the selected advertisement 58 includes a product related to a specific person, Alex Rodriguez, despite the fact that Alex Rodriguez was not specifically named in the query 46. Additionally, as mentioned above, the text of the selected advertisement 58 includes dynamic text, as “Alex Rodriguez” was included in the advertisement without being specifically named in the query 46. Thus, the webpage/business for which the selected advertisement 58 is being shown is able to have an advertisement for a specific item shown without that specific item being specifically, or corrected, indicated within the query 46.

The properties 54 may also be sent to a server 60 of the advertiser as the advertiser may wish to store various information about the properties generated verse the advertisements that are shown. The server 60 may also incorporate the properties 54 to generate the dynamic text within the selected advertisement 58.

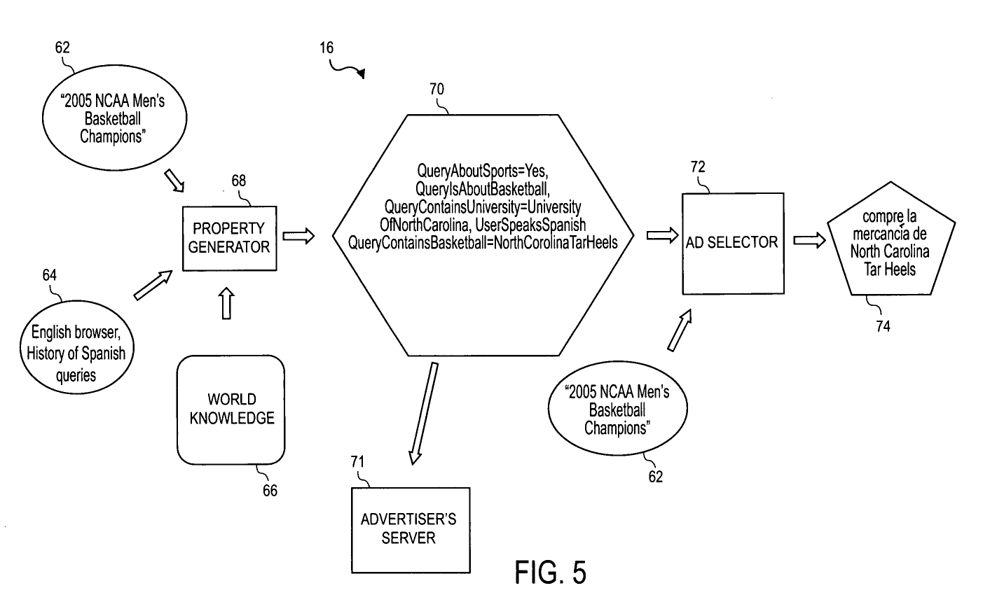

FIG. 5 illustrates a further specific example of the method and system 16 illustrated in FIG. 2. As shown, the user enters the English query 62 of “2005 NCAA Men's Basketball Champions.” The information 64 about the user includes, amongst other things, that the user is navigating the internet on a browser that is set to the English language and the user has previously entered a number a queries in Spanish.

As described before, the query 62, the information 64 about the user, and world knowledge 66 are received by the property generator 68 and a number of properties 70 are generated. The properties 70 include, amongst others, “QueryIsAboutSports=Yes,” “QueryIsAboutBasketball,” “QueryContainsUniversity=UniversityOfNorthCarolina,” “QueryContains BasketballTeam=NorthCarolinaTarHeels” and “UserSpeaksSpanish.” The discovery to include the North Carolina Tar Heels could have been the result of a question-and-answer engine.

The properties 70 are then sent to the ad selector 72 which, similarly as described above, selects an appropriate advertisement 74. The selected advertisement 74 is for a webpage/business to “compre la mercancia de North Carolina Tar Heels”, meaning “Buy North Carolina Tar Heels Memorabilia” in English. An advertiser server 71 is also included in FIG. 4.

Of particular interest in the example shown in FIG. 5 is that the system 16 selected an advertisement in Spanish because of the property “UserSpeaks Spanish” despite the fact that the query 62 was in English. Also, as described above, the selected advertisement 74 included text (i.e., “North Carolina Tar Heels”), in Spanish, that was not in the query 62 in either English or Spanish.

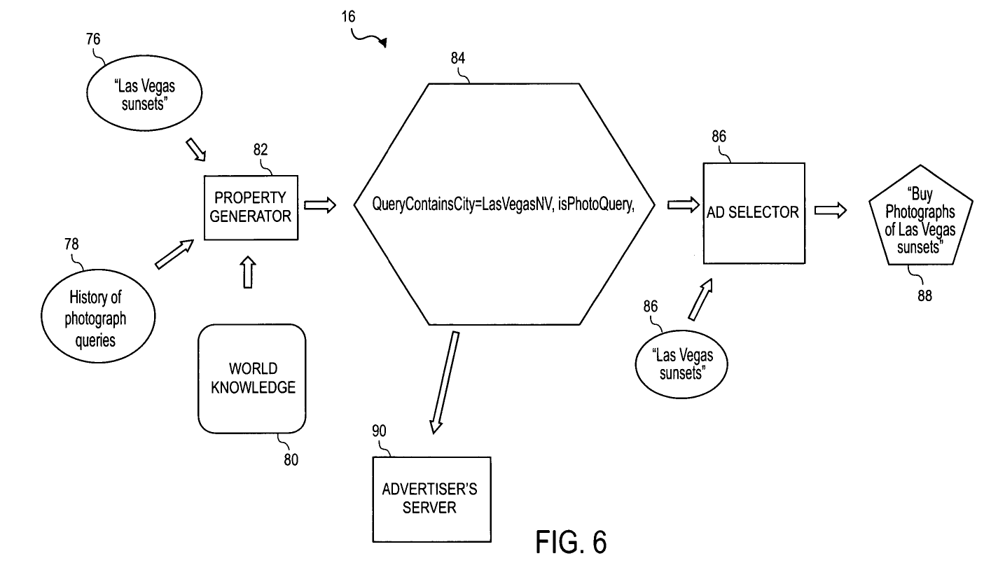

FIG. 6 illustrates yet a further specific example of the method and system 16 illustrated in FIG. 2. As shown, the user enters the query 76 of “Las Vegas sunsets.” The information 78 about the user includes, amongst other things, that the user has previously entered a number of queries pertaining to photographs.

The query 76, and real-world knowledge 80 are received by the property generator 82 which generates a number of properties 84. Although not illustrated in detail, the real-world knowledge 80 may include statistical data which indicates the previous users who have entered queries including “Las Vegas sunsets” have been searching for photographs of sunsets in the Las Vegas area.

The properties 84 are then sent to the ad selector 86 which, as described above, selects an appropriate advertisement 88. The selected advertisement 88 is for a webpage/business to “Buy Photographs of Las Vegas Sunsets.” As shown, the properties 84 may also be sent to a server 90 of the advertiser who may collect further statistical data on the occurrences of particular combinations of properties, in this case, the combination of the user's search history and the presence of “Las Vegas” may be particularly relevant. This statistical data may also be added to the real-world knowledge 80 to further define the relationship between the search term “Las Vegas sunsets” and photograph queries.

Again, it should be noted that in the example illustrated in FIG. 6, the selected advertisement 88 includes a specific subject matter, and text, that was not specifically stated in the query 76. Rather, the subject matter of the query 76 was combined with the information 78 about the user and real-world knowledge 80 to show the user a advertisement, or webpage, which was not specified in the query 76. However, given the user's search history, the selected advertisement 88 is very likely something in which the user may be interested.

One advantage is that an ambiguity in a query is more particularly resolved. For example, if the query is “football,” the country in which the visitor lives can be used to determine the most likely meaning of the word “football.” If the visitor lives in the United States, the visitor is most likely searching for information about American football. However, if the visitor lives in Brazil, the visitor is probably looking for information about the sport known in the United States as soccer.

Another advantage is that advertisers can more accurately target visitors on the WWW because advertisements can be sent to visitors based on multiple properties, or concepts. For example, if the query is “photos of Alex Rodriguez,” the properties generated will include that the query is for photographs and that the query contains the name of a professional athlete. Thus, an advertiser a visitor who is searching for not only photographs, but more specifically, photographs of a MLB player.

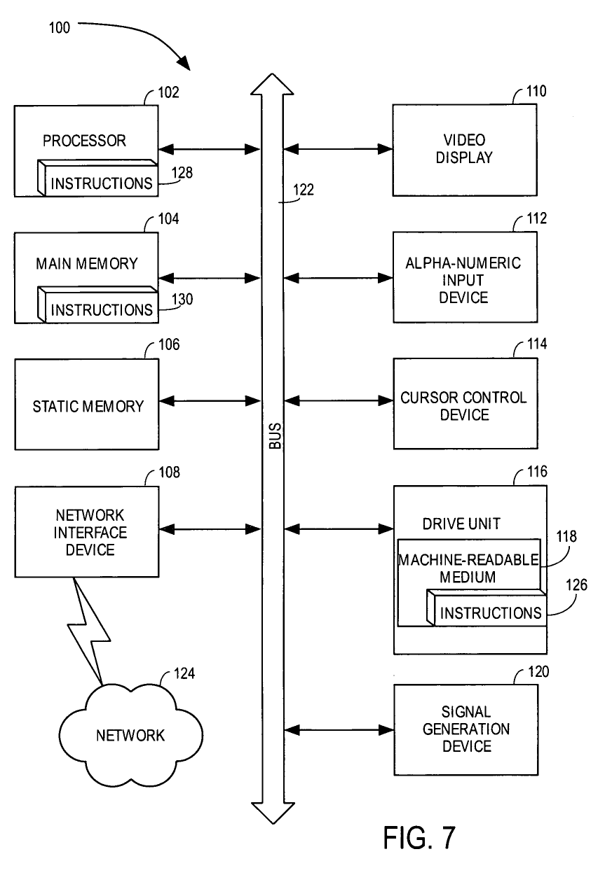

FIG. 7 illustrates a computing system 100 that on which the above described method and system may be implemented. The computing system includes a processor 102, a main memory 104, a static memory 106, a network interface device 108, a video display 110, an alpha-numeric input device 112, a cursor control device 114, a drive unit 116 including a machine-readable medium 118, and a signal generation device 120. All of the components of the computing system 100 are interconnected by a bus 122. The computing system 100 may be connected to a network 124 through the network interface device 108.

The machine-readable medium 118 includes a set of instructions 126, which may be partially transferred to the processor 102 and the main memory 104 through the bus 122. The processor 102 and the main memory 104 may also have separate internal sets of instructions 128 and 130.

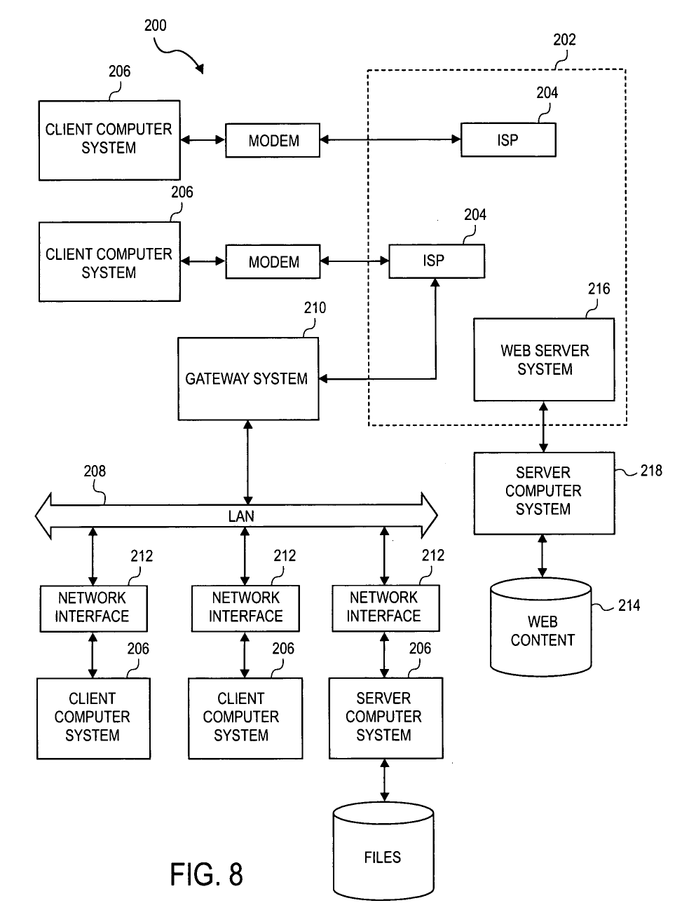

FIG. 8 illustrates a computer network system 200 on which the method and system described above may be implemented. The system 200 includes numerous computers, such as the one illustrated in FIG. 4, connected through a network 202, such as the internet. The term “internet” refers to a network of smaller networks which uses certain protocols, such as the TCP/IP protocol and the hypertext transfer protocol (HTTP) for hypertext markup language (HTML) documents that make up the World Wide Web (WWW). Access to the internet is typically provided by internet service providers (ISPs) 204.

Users on client systems 206, such as client computer systems, obtain access to the internet 202 though the ISPs 204. Alternatively, the client systems 206 can be connected to the internet 202 through a local area network (LAN) 208 and a gateway system 210. The client systems 206 are typically connected to the LAN 208 through network interfaces 212.

Access to the internet 202 allows users of the client computer systems 206 to exchange information, receive and send emails and instant messages, and view web content, such as documents prepared in HTML format. Additionally, the web content 214 includes information from various news sources about current events and other real-world knowledge. These documents are often provided by web servers which are considered to be “on” the internet, or the WWW. Web content 214 is typically managed by a web server 216 and a server computer 218.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A machine-implemented method for managing navigation across the World Wide Web comprising:
determining a target profile based on a combination of at least two known properties; and
associating a navigation path with the target profile.

2. The method of claim 1, wherein the at least two known properties are each related to at least one of a query, world knowledge, and information about a visitor to the World Wide Web.

3. The method of claim 2, further comprising:
receiving the at least one of a query, information about a visitor to the World Wide Web, and world knowledge; and
associating each known property with the at least one of the query and the information about the visitor.

4. The method of claim 3, further comprising automatically directing the visitor to the navigation path associated with the target profile.

5. The method of claim 4, wherein the properties comprise categorizations of the at least one of a query, information about a visitor to the World Wide Web, and world knowledge.

6. The method of claim 5, further comprising generating the properties using at least one of keyword matching, classification, natural language processing, list matching, question answering technology and ambiguity resolution.

7. The method of claim 6, wherein said listing matching includes at least one of static and dynamic lists.

8. The method of claim 7, wherein the information about the visitor includes at least one of the visitor's location, IP address, previous queries, demographic data, and previous navigation paths.

9. The method of claim 4, wherein the properties do not include the query, and the navigation path to which the visitor is automatically directed includes dynamic text which comes from a property.

10. The method of claim 4, further comprising displaying information specific to at least one of the properties within the selected navigation path.

11. The method of claim 4, wherein the properties comprise categorizations that do not include the at least one of a query, information about a visitor to the World Wide Web, and world knowledge.

12. The method of claim 4, wherein the selected navigation path comprises an advertisement.

13. The method of claim 12, wherein at least one of the properties is sent to a target company when the user selects the advertisement.

14. The method of claim 5, wherein the generation of the properties comprises at least one of correcting spelling of a term in the query, replacing an abbreviation in the query, resolving a reference, question answering and replacing alternative form in the query.

15. A computer-readable medium including program code which, when executed by a machine, causes the machine to perform a method, the method comprising:
determining a target profile based on a combination of at least two known properties; and
associating a navigation path with the target profile.

16. The computer-readable medium of claim 15, wherein the method further comprises:
receiving at least one of a query, information about a visitor to the World Wide Web, and world knowledge, wherein the properties are each related to the at least one of a query, world knowledge, and information about a visitor to the World Wide Web.; and
associating each known property with the at least one of the query and the information about the visitor.

17. The computer-readable medium of claim 16, wherein the method further comprises automatically directing the visitor to the navigation path associated with the target profile.

18. The computer-readable medium of claim 17, wherein the properties comprise categorizations of the at least one of a query, information about a visitor to the World Wide Web, and world knowledge.

19. The computer-readable medium of claim 18, wherein the information about the visitor includes at least one of the visitor's location, IP address, previous queries, demographic data, and previous navigation paths.

20. A computing system comprising instructions disposed on a computer readable medium, said instructions capable of being executed by said computing system to perform a method, said method comprising:
determining a target profile based on a combination of at least two known properties; and
associating a navigation path with the target profile.

21. The computing system of claim 20, wherein the method further comprises:
receiving at least one of a query, information about a visitor to the World Wide Web, and world knowledge, wherein the properties are each related to the at least one of a query, world knowledge, and information about a visitor to the World Wide Web.; and
associating each known property with the at least one of the query and the information about the visitor.

22. The computing system of claim 21, wherein the method further comprises automatically directing the visitor to the navigation path associated with the target profile, and wherein the properties comprise categorizations of the at least one of a query, information about a visitor to the World Wide Web, and world knowledge.

23. The computing system of claim 22, wherein the information about the visitor includes at least one of the visitor's location, IP address, previous queries, demographic data, and previous navigation paths.

24. A machine-implemented method for managing navigation across the World Wide Web comprising:
receiving at least one of a query, information about a visitor to the World Wide Web, and world knowledge;
determining a target profile based on a combination of at least two known properties, wherein the at least two known properties are each related to the at least one of a query, information about a visitor to the World Wide Web, and world knowledge, the at least two known properties comprising categorizations of the at least one of a query, information about a visitor to the World Wide Web, and world knowledge and categorizations that do not include the at least one of a query, information about a visitor to the World Wide Web, and world knowledge; and
associating a selected advertisement with the target profile.

25. The method of claim 24, further comprising automatically directing the visitor to the advertisement associated with the target profile.

26. The method of claim 25, further comprising generating the properties using at least one of keyword matching, classification, natural language processing, list matching, question answering technology and ambiguity resolution.

27. The method of claim 26, wherein the generation of the properties comprises at least one of correcting spelling of a term in the query, replacing an abbreviation in the query, resolving a reference, question answering and replacing alternative form in the query.

28. A machine-implemented method for managing navigation across the World Wide Web comprising:
determining a target profile based on at least two different queries by a user; and
associating a navigation path with the target profile.

29. A computer-readable medium including program code which, when executed by a machine, causes the machine to perform a method, the method comprising:
determining a target profile based on at least two different queries by a user; and
associating a navigation path with the target profile.

30. A computing system comprising instructions disposed on a computer readable medium, said instructions capable of being executed by said computing system to perform a method, said method comprising:
determining a target profile based on at least two different queries by a user; and
associating a navigation path with the target profile.

31. A machine-implemented method for managing navigation across the World Wide Web comprising:
receiving at least one of a query, information about a visitor to the World Wide Web, and world knowledge;
determining a target profile based on at least two different queries by a user, wherein the at least two known properties are each related to the at least one of a query, information about a visitor to the World Wide Web, and world knowledge, the at least two known properties comprising categorizations of the at least one of a query, information about a visitor to the World Wide Web, and world knowledge and categorizations that do not include the at least one of a query, information about a visitor to the World Wide Web, and world knowledge; and
associating a selected advertisement with the target profile.
